(19) United States
(12) Patent Application Publication
(10) Pub. No.: US 2021/0282598 A1
(43) Pub. Date: Sep. 16, 2021

(54) Flavor Spike

(71) Applicant: Jamal Jackson, Detroit, MI (US)

(72) Inventor: Jamal Jackson, Detroit, MI (US)

(21) Appl. No.: 16/813,739

(22) Filed: Mar. 10, 2020

(51) Int. Cl. A47J 43/16; A23B 4/28; A47J 43/28; A22C 17/00

(52) U.S. Cl. CPC A47J 43/16; A23B 4/28; A23V 2002/00; A22C 17/0053; A47J 43/288

(57) ABSTRACT

The present invention relates to an improved meat tenderizing and cooking device for domestic use for the item to be thoroughly cooked from inside and outside. The invention has a fluid reservoir that will be transmitted to inner-parts of the food to be cooked through needles once pressed.

### BACKGROUND

### Copyright Notice

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### Field of the Invention

The invention relates to devices and method for cooking food, and more particularly to a device and method for tenderizing and marinating of food by infusing with flavor and moisture, and also cooking food more evenly and quickly.

### Description of the Related Art

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Variety of techniques have been used to tenderize and marinate meats so that it is not tough and hard to chew, and to improve their taste. Tenderizing methods include pounding using a tenderizing mallet or other instrument, and piercing using a mechanical tenderizer having sharp blades. U.S. Pat. No. 4,199,841 of Jaccard is illustrative of the latter type of tenderizer. It features a handle that mounts a set of tenderizing blades. A spring-biased stripping plate normally covers the ends of the blades. The stripping plate retracts when the device is pressed downwardly on a cut of meat and the blades are driven into the meat interior. Marinating methods include external marination by soaking the meat in a liquid marinade. There are also internal marinating devices that can be used to directly introduce marinade into the interior of the meat. Such devices typically include a marinade holder and one or more injectors for injecting the marinade into the meat. In U.S. Pat. No. 4,254,700 to Flemming, the appliance is used for pre-basting, seasoning and tenderizing meat and poultry. The appliance comprises in a single hand held unit, one or more hollow needles through which liquid such as baste or tenderizer is injected into the meat or poultry, a reservoir which accommodates the liquid and an electrically operated pump, which pumps the liquid from the remote reservoir through the injection needles.

Conventionally, seasonings, tenderizers and preservatives and similar additives in granular or powdered form are sprinkled over food, such as meat, turkey and chicken, or fluid substances are used, but the substances do not penetrate the food body sufficiently to produce a desired uniform effect throughout the consumable body. While the consumable body is sometimes pierced with a fork or even pounded, these methods leave much to be desired in the results obtained, and it has been found that spices, seasonings, flavoring compounds and preservative fluids or the like can be injected easily into a consumable body such as meat and this can be accomplished either during cooking or prior to the cooking process.

The present device described in this disclosure combines the two meat preparation processes of tenderizing and basting, including an efficient method of infusing marinade solutions in a simple handheld device for domestic use, while overcoming the inherent drawbacks of prior art. None of the prior art methods have been found to be completely suitable to meet these needs and are cumbersome. The present invention provides such a method and the overall combination of these features is nowhere disclosed in the prior art cited above which appears to be representative of the general art in this area although it is not intended to be an all-inclusive listing of pertinent prior art patents.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, and abstract as a whole.

In order to solve the above problems, the present invention is a device used to cook food more thoroughly from the inside of chicken, meatloaf and steaks. The device must be pressed firmly and left inside while the food cooks as it will allow the heat to circulate through the holes into the foods to avoid under cook food.

Another embodiment of the present invention relates to dual functionality of the holes that allows for liquid seasonings to be poured through the top of the device and permitted to drain down into the food thus disseminating the liquid seasonings into the food as well as heat.

It is a primary object of the present to provide device with a thermometer to measure temperature of food to prevent undercooked or overcooked food.

Another embodiment of the device is that it has detachable spatula to use in conjunction with device to help facilitate process preventing food from sticking to device.

Yet another object of the present invention is to provide a device that allows to equally cook the chicken, meatloaf and steaks consistent throughout.

Briefly, it is a principal object number of the invention to provide a solution that is cost-effective and can be cheaply made.

A further object of this invention is to provide a handheld tenderizer that is easy and effective to use.

Still another object of the invention is to provide a device which it is capable of adjustment to regulate the amount of fluid or seasoning material that will be discharged upon the operation of the device according to the invention.

Another embodiment of the device relates to creating holes in the food to allow heat and liquid to flow consistently.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 100 is a top view of spatula.

FIG. 200 shows bottom view of spatula.

FIG. 300 shows side view of the spatula.

FIG. 400 shows the top view of the invention.

FIG. 500 shows bottom view of the invention.

FIG. 600 is an exploded view of the invention with spatula.

FIG. 700 is a side view of the invention with spatula.

FIG. 800 is a top view of the invention with spatula.

FIG. 900 shows side view of the invention with spatula.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

Unless otherwise defined, all terms (including technical and scientific terms) used herein have the same meaning as commonly understood by one having an ordinary skill in the art to which the invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques are disclosed. Each of these has individual benefit and each can also be used in conjunction with one or more, or in some cases all, of the other disclosed techniques. Accordingly, for the sake of clarity, this description will refrain from repeating possible combination in an unnecessary fashion. Nevertheless, the specifications and claim/s should be read with the understanding that such combinations are entirely within the scope of the invention and the claim/s.

The invention relates to a device used in the preparation and/or process of cooking, baking, frying and/or grilling. It is made up of casting metal and/or plastic into a mold creating a multi-spiked apparatus with two parts molded together. The top part having an oval shape with walls made like a cup to hold small amounts of liquid having multiple holes in the face of device. The holes in top part flows liquid down through the bottom part which is made of multiple spikes with a hole through the top of each spike corresponding with the holes in top part as well as multiple holes through the sides of spikes.

The device must be pressed down into the food (burgers, steaks, chicken, meatloaf) firmly and left inside while the food cooks as it will allow the heat to circulate through the holes into the foods interior. Also the holes have a dual purpose being that it allows for liquid seasonings to be poured through the top of the device and allowed to drain down into the food thus distributing the liquid seasonings into the food as well as heat.

Another embodiment of the invention relates to fluid which can comprise marinades, flavor oils, juices, water, broths, etc.

The infusers in all of the embodiments are preferably made of a heat resistant material.

In another embodiment, to control the temperature the device is equipped with a thermometer to prevent undercooked or overcooked food but allows the preparer to determine its desired temperature for the item being cooked.

The device has detachable spatula to use in conjunction with device to help facilitate process preventing food from sticking to device.

The invention comprises a lower body needle manifold having a plurality of needles configured to pierce meat attached thereto, and to provide a fluid path between the device and the meat.

The device can be incorporated into an oven, or can be a unit designed to retrofit conventional ovens, grills, barbeques and the like, or in the alternative, can be a stand-alone portable unit.

As stated, the device may be repeatedly pressed downwardly into the meat, withdrawn from the meat and pressed downwardly again at a different location. Each time the device is pressed downwardly, a combination of tenderizing and cooking actions will be applied to the meat in a synergistic manner, causing it to tenderize and cook more quickly and thoroughly.

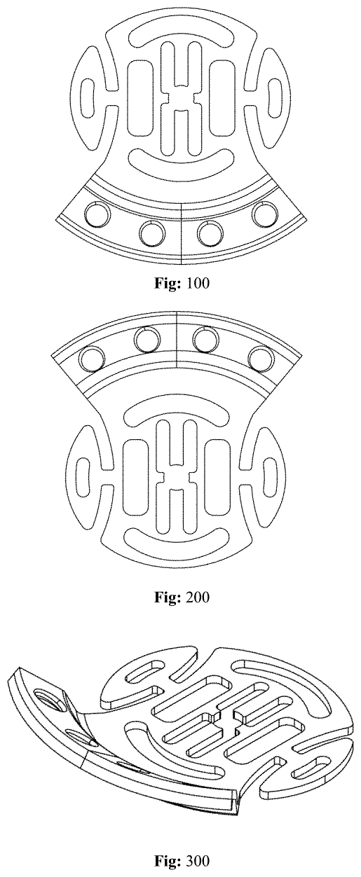

FIG. 100 is a top view of spatula which must be placed on top of food underneath Flavor Spike and Flavor Spike pressed through holes of spatula down into food. FIG. 200 shows bottom view of spatula. FIG. 300 shows side view of the spatula.

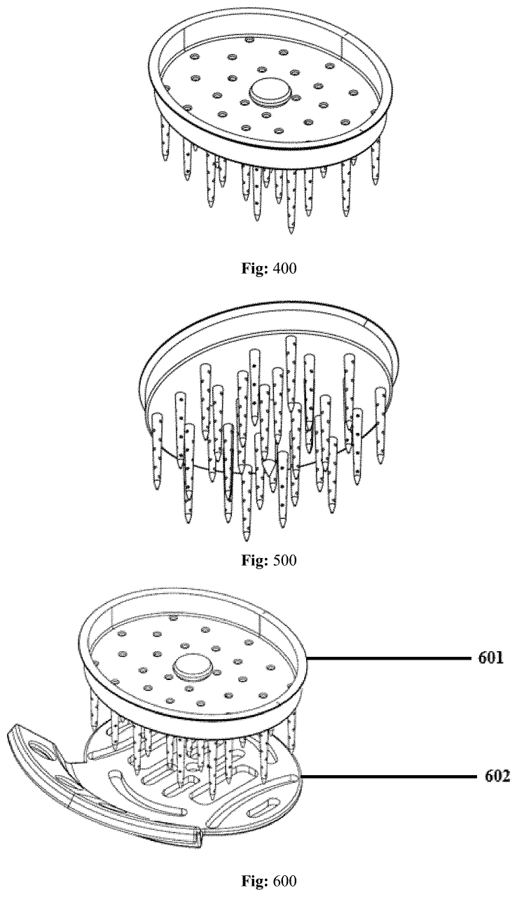

FIG. 400 shows the top view of the invention which creates holes in food to allow heat to flow up through. FIG. 500 shows bottom view of the invention with needle like structure to penetrate into the foods interior.

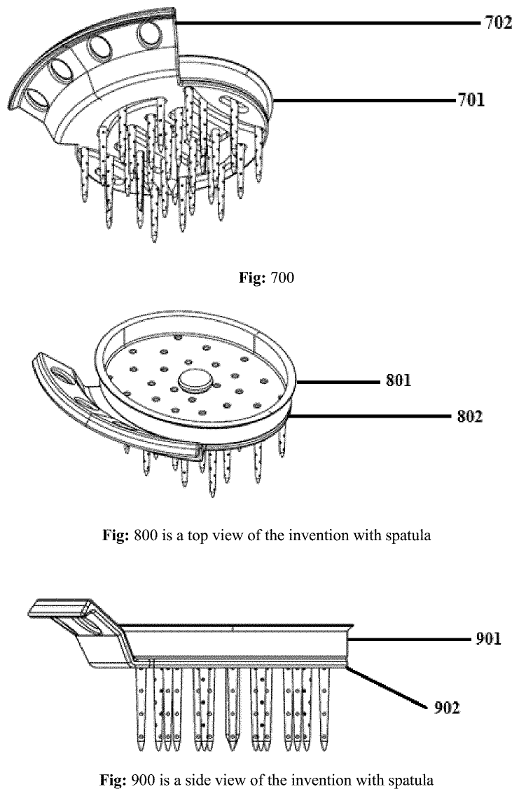

FIG. 600 is an exploded view of the invention showing invention 601 on top of the spatula 602. FIG. 700 is a side view of with detachable spatula 702 to use in conjunction with the invention 701 to help facilitate process preventing food from sticking to device. FIG. 800 is a top view of the invention 801 with spatula 802 fixed together to operate. FIG. 900 shows side view of the invention 901 with spatula 902.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1) An injection system for injecting seasoning solutions into meat comprising needles to creates holes in food to allow liquid through a fluid reservoir to be poured down into for quick and through cooking of food.

2) Wherein the device consist of spatula attachment to prevent food from sticking to device and a thermometer which measures the temperature of the food to prevent undercooked or overcooked food and allows the preparer to determine its desired temperature.

3) Wherein the top part has an oval shape with walls made like a cup to hold small amounts of liquid to be dispersed in the food through injecting needles.
